(19) United States
(12) Patent Application Publication
(10) Pub. No.: US 2025/0370152 A1
(43) Pub. Date: Dec. 4, 2025

(54) Estimating Seismic Wavefront Attributes

(71) Applicant: Saudi Arabian Oil Company, Dhahran (SA)

(72) Inventors: Ilya Silvestrov, Dhahran (SA); Andrey Bakulin, Dhahran (SA)

(21) Appl. No.: 18/733,252

(22) Filed: Jun. 4, 2024

(51) Int. Cl. G01V 1/36

(52) U.S. Cl. CPC G01V 1/364; G01V 2210/21; G01V 2210/22

(57) ABSTRACT

A computer implemented method that constrains prestack seismic wavefront attributes is described. The method includes estimating wavefront attributes in intervals sized to include a representative subset of an original seismic dataset and applying a semblance threshold to the wavefront attributes based on an estimated semblance value, wherein wavefront attributes that satisfy the semblance threshold are retained. The method also includes transforming the retained wavefront attributes to reduce a range of possible values and selecting minimum and maximum values of the wavefront attributes based on statistical criteria. The method includes estimating wavefront attributes for the original seismic dataset using the selected minimum and maximum values.

### TECHNICAL FIELD

This disclosure relates generally to exploration seismology and, more specifically, to seismic data processing.

### BACKGROUND

Seismic data contains information about various geological features. Seismic data can be obtained from seismic surveys to image geological structures of a subterranean region. Poststack seismic data can include two-dimensional (2D) seismic slices or three-dimensional (3D) seismic volumes. On the other hand, prestack seismic data can have higher dimensions including source and receiver positions arranged in orthogonal directions. For example, a seismic data volume can be represented as a five-dimensional (5D) prestack seismic cube with the dimensions of two source coordinates, two receiver coordinates, and time.

### BRIEF DESCRIPTION OF DRAWINGS

FIG. 1 shows a workflow to optimize the search intervals for estimating wavefront attributes.

FIG. 2 shows an example of seismic data.

FIG. 3 shows histograms with a distribution of estimated semblance values.

FIG. 4 shows estimated maximum semblance values.

FIG. 5 shows the new transformed wavefront attributes obtained after the rotation.

FIG. 6 shows a distribution of wavefront attribute values before and after rotation.

FIG. 7 is a process flow diagram of a process that constrains prestack seismic wavefront attributes for estimation.

FIG. 8 illustrates hydrocarbon production operations that include both one or more field operations and one or more computational operations, which exchange information and control exploration for the production of hydrocarbons.

FIG. 9 is a schematic illustration of an example controller (or control system) for estimating seismic wavefront attributes.

Like reference numbers and designations in the various drawings indicate like elements.

### DETAILED DESCRIPTION

The following detailed description describes methods and systems for enhancing single sensor seismic data. Various modifications, alterations, and permutations of the disclosed implementations can be made and will be readily apparent to those of ordinary skill in the art. Further, the general principles defined may be applied to other implementations and applications, without departing from the scope of the disclosure. In some instances, details unnecessary to obtain an understanding of the described subject matter may be omitted so as to not obscure one or more described implementations with unnecessary detail since such details are within the skill of one of ordinary skill in the art. The present disclosure is not intended to be limited to the described or illustrated implementations. Furthermore, the present disclosure is to be accorded the widest scope consistent with the described principles and features. In this disclosure term “local” refers to seismic signals not globally, across a data gather, but locally in the neighborhood of each trace and time sample point.

For various reasons, three-dimensional (3D) land seismic data acquisition varies from sparse grids of large source/receiver arrays to arrays of denser grids that include smaller arrays or point-source, point-receiver systems. These arrays, also called modern arrays, use single sensors or small source and receiver arrays to acquire land seismic data with a high spatial trace density (also called modern land seismic data). Such datasets are challenging to process due to their massive size and low signal-to-noise ratio (SNR), which is caused, for example, by scattered near surface noise. Due to the challenging nature of these datasets, prestack data enhancement is used in their processing.

Seismic data acquired in arid environments with small field arrays or single-sensor systems often possesses low level of signal in the records due to strong scattering in the near-surface. This complicates data processing and, in particular, application of full-waveform inversion or refraction-tomography algorithms to estimate a velocity model corresponding to the shallow part of the subsurface. To overcome this scattering and other artifacts, prestack data enhancement algorithms based on local multidimensional stacking such as nonlinear beamforming can be applied to accumulate the signal and improve the signal-to-noise level. To perform the stacking optimally, local wavefront attributes describing the kinematics of the wavefield are estimated by optimizing a coherency-based penalty function. Ranges or intervals are set to initialize the search algorithms. The intervals denote possible wavefront attribute values within which the optimization is performed. Such intervals are parameters of the optimization processes and strongly affect quality of the prestack data enhancement, and ultimately the computational performance of seismic data processing.

The present disclosure describes estimation of prestack wavefront attributes. In some embodiments, an automated process to constrain searching intervals is based on a combination of statistical and physical properties of the wavefront attributes. Initial wavefront attributes are estimated within initial search intervals on a small but representative subset of the whole, original dataset associated with the current seismic exploration block. A thresholding of the wavefront attributes based on a semblance value is performed to keep only the most reliable events. A transformation of the wavefront attributes reduces the ranges of possible values. The minimum and maximum values of the wavefront attributes are selected based on, at least in part, statistical criteria in the transformed domain. The selected ranges are used to estimate the wavefront attributes. In examples, the wavefront attributes are estimated for the whole, original dataset.

The subject matter described in this disclosure can be implemented to realize one or more of the following advantages. The disclosed prestack data enhancement workflow generates high-quality wavefront attributes at a reduced computational cost compared to existing solutions. In particular, the quality of the generated wavefront attributes is at least similar to or exceeds the quality of wavefront attributes generated using existing solutions that are more computationally expensive. Additionally, the disclosed workflow enhances seismic data to achieve an objectively high SNR at a reasonable computational cost. Specifically, not only is the quality of the enhanced seismic data achieved using the disclosed workflow at least similar to the quality of enhanced data achieved using existing solutions, but also the computational cost of the disclosed workflow is at least 10 times less than the computational cost of existing solutions. Furthermore, unlike existing solutions which lose high-frequency content when enhancing seismic data, the disclosed algorithm preserves the high-frequency content of the seismic data. Other advantages will be apparent to those of ordinary skill in the art.

Traditionally, three-dimensional (3D) land seismic data acquisitions have been performed with sparse grids of large field arrays that include a number of geophones on the order of high 10s to low 100s (for example, 72 geophones or more). These large field arrays with 5-10 meter (m) intra-array spacing were designed to attenuate strong noise caused by ground-roll and multiple scattering in the near-surface. Theoretically, denser data sampling and decreased array size should improve sampling of the noise wavefield, thereby facilitating its attenuation during the processing stage. In practice, however, high-density surveys with uniform and dense sampling in all directions remain prohibitively expensive with current sensor technology.

In recent practice, in order to overcome the limitations of large field arrays, orthogonal 3D surveys are acquired using small field arrays (that is, smaller than traditional field arrays) with smaller inline and much larger crossline spacing than traditional field arrays. The small field arrays include a number of geophones-per-channel on the order of low 10s or even in the single digits (for example, 15 geophones or less). These surveys have a high-channel count. For example, some high-channel count surveys have a trace density of around 15 million traces/kilometer² (traces/km²). More dense point-receiver surveys acquired with 50,000-100,000 active channels can reach 100 million traces/km² and more. This leads to better spatial sampling of the seismic wavefield and is expected to improve final images after processing.

However, using small arrays or single sensors results in massive datasets with low signal-to-noise (SNR) ratios that are challenging to process. Processing prestack data in these seismic datasets is particularly challenging because the signals (for example, reflections) are masked by noise. For example, it is challenging and unreliable to apply conventional time processing algorithms to the prestack data because the derived processing parameters are based on noise. Additionally, conventional processing techniques such as surface-consistent scaling and deconvolution, statics estimation, and velocity analysis, all require a threshold prestack SNR to be effective and deliver suboptimal results otherwise. This especially affects the quality of prestack inversion, which requires reliable and accurate prestack amplitudes in seismic gathers. In order to improve the reliability and utility of seismic datasets that are acquired by small field arrays, the noise in the prestack data is suppressed and the prestack signals is enhanced.

Several existing enhancement procedures are used to enhance prestack data. These procedures, which are generally referred to as SNR enhancement procedures, include multi-dimensional data-driven stacking techniques, such as the common-reflection surface method (CRS) and multi-focusing (MF). These techniques have also been adopted for two-dimensional (2D) and three-dimensional (3D) cases in a procedure called non-linear beamforming (NLBF). The common feature amongst these procedures is the local stacking of coherent signals registered by neighboring traces. To obtain reliable signals from noisy data, SNR enhancement procedures require large stacking apertures that can reach hundreds of meters. Furthermore, the procedures require several hundred (or even thousands) of traces to produce an output trace with an increased SNR that is acceptable for processing.

This disclosure describes an automated process to constrain prestack seismic wavefront attributes. In some embodiments, the prestack seismic wavefront attributes are constrained for efficient estimation. In some embodiments, the prestack seismic wavefront attributes are constrained for estimation at a reasonable cost. In examples, an automated process to constrain the searching intervals is based on a combination of statistical and physical properties of the wavefront attributes. Initial wavefront attributes are estimated within initial search intervals on a small but representative subset of the whole dataset. A thresholding of the wavefront attributes based on a semblance value is performed to retain the most reliable events. In examples, reliability of events is determined based on, at least in part a semblance value. For example, a high semblance value corresponds to a reliable event. In examples, reliable events are strong and coherent events. Coherent refers to seismic events that show continuity from trace to trace. A transformation of the wavefront attributes reduces the ranges of possible values. The minimum and maximum values of the wavefront attributes are selected based on, at least in part, statistical criteria in the transformed domain. The selected ranges are used to estimate the wavefront attributes for the whole dataset. In examples, the wavefront attributes are estimated for large datasets using sequential estimation of wavefront attributes on a sparse estimation grid, interpolation of the estimated wavefront attributes to a dense estimation grid, group data summation of the data to a sparse grid, operator-oriented summation from the sparse grid to a dense original data grid, amplitude-phase correction of the summed data, or any combinations thereof. In examples, the wavefront attributes are estimated using artificial intelligence.

Using the estimated wavefront attributes, data enhancement such as deconvolution, followed by stacking and migration can be performed such that the final processed results are displayed for visualization. The disclosed embodiments may advantageously operate without the classical assumptions about hyperbolicity of seismic events. However, such embodiments may use an available stacking velocity as a guide to enhance primary reflections and to suppress other unwanted events such as multiples.

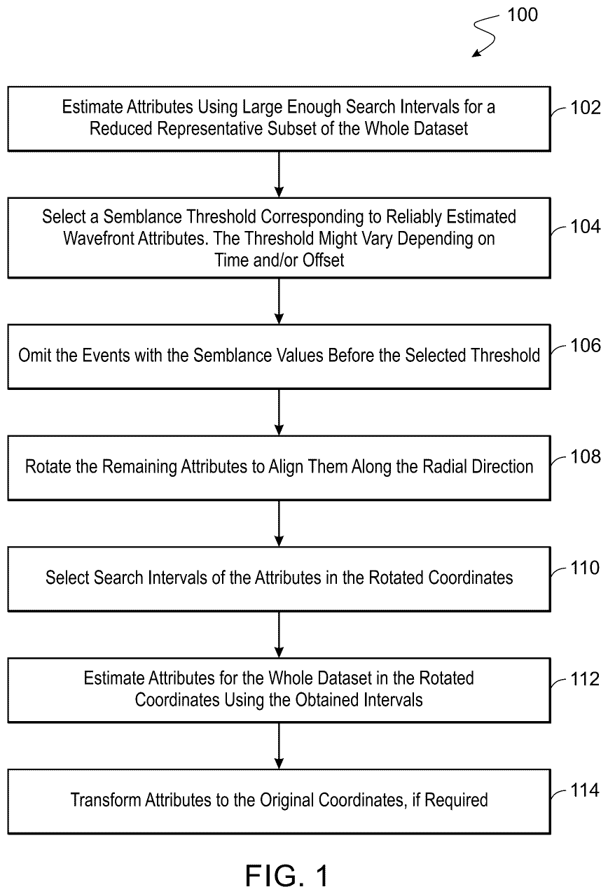

FIG. 1 shows a workflow to optimize search intervals for wavefront attributes. In some embodiments, the wavefront attributes are estimated and used in SNR enhancement procedures. In examples, the wavefront attributes are based on a nonlinear beamforming (NLBF) data enhancement method. In examples, the disclosed process can be applied to generate an enhanced dataset using an SNR enhancement procedure. Weak reflections in the seismic data are identified and interpreted to generate an enhanced dataset. In particular, the enhanced dataset is constructed using local traveltime information about desired arrivals. Each trace of the enhanced dataset is constructed by stacking of neighboring traces of original (noisy) dataset along specifically determined trajectories within predefined apertures. These trajectories describe time delays of corresponding arrivals of reflected waves in some vicinity of an enhanced trace. This is considered delay-and-sum beamforming. Details of SNR enhancement procedures are disclosed in PCT/RU2018/000079, titled “Systems and Methods to Enhance 3-D Prestack Seismic Data Based on Non-Linear Beamforming in the Cross-Spread Domain,” which is incorporated by reference. Details of SNR enhancement procedures are disclosed in PCT/RU2020/000469, titled “Enhancement of Single Sensor Seismic Data,” which is incorporated by reference. For ease of description, particular enhancement and beamforming is described herein. However, the searching as described herein can be implemented in other approaches and applications beyond particular examples as described herein.

Three dimensional (3D) single sensor seismic data is received. The 3D single sensor seismic data is generated using a seismic survey performed by small arrays or single sensors. In some examples, the seismic data volume can be represented as a 5D cube with the dimensions of two source coordinates, two receiver coordinates (at the surface), and time.

The first step in multi-dimensional stacking is to estimate the wavefront attributes (e.g., kinematic parameters), which locally describe traveltimes. In some embodiments, traveltime moveout is described locally as a second-order surface. Considering a data space with a coordinate vector \vec{x}=(xₛ, yₛ, xᵣ, yᵣ) defined by source and receiver x, y coordinates, the traveltime, t, can be locally represented using a Taylor series expansion. The Taylor series expansion includes fourteen unknown coefficients (that is, wavefront attributes or kinematic parameters) that define the local traveltime surface at a sample. From a computational standpoint, estimating all fourteen kinematic parameters is too costly.

According to the formula below, seismic data enhancement with NLBF constitutes a local summation of neighboring traces using local time-shift corrections:

$$u ( {x}_{0} , {y}_{0} , {t}_{0} ) = {\sum }_{x ∈ {B}_{0}} w ( x , y ) u ( x , y , {t}_{0} + Δ t ( x , y ; {x}_{0} , {y}_{0} ) ) , \qquad ( 1 )$$

where u(x, y; t) is a trace with spatial coordinates x and y and time t defined at each point of a 3D X-Y-T prestack data sub-volume. The two spatial coordinates are arbitrary and depend on the type of input seismic gather. It could be either shot X and Y coordinates if common-shot data is considered, receiver X and Y coordinates in the case of common receiver data, or shot X and receiver Y coordinates if the cross-spread gathers are considered. The enhanced trace's coordinates after beamforming are given by x₀ and y₀. The summation is accomplished within a local rectangular region B₀ around the position of the enhanced trace along a traveltime surface with a moveout Δt(x, y; x₀, y₀). In NLBF, it is assumed that a second-order surface can locally approximate this moveout as follows:

$$Δ t = t ( x , y ) - {t}_{0} ( {x}_{0} , {y}_{0} ) = A Δ x + B Δ y + C Δ x Δ y + D Δ {x}^{2} + E Δ {y}^{2} , \qquad ( 2 )$$

where A, B, C, D, E are unknown wavefront attributes, Δx=x−x₀ and Δy=y−y₀ represent spatial shifts of the summed trace with respect to the output trace. The wavefront attributes are defined independently for each 3D input seismic gather on a regular estimation grid in the X-Y-T volume. They are functions of the prestack time and the spatial point coordinate and are local in this regard. The unknown coefficients A, B (wavefront first spatial derivatives, or dips) and C, D, E (wavefront second derivatives, or curvatures) are estimated on some grid of possible values by using either a brute-force searching or global optimization algorithm to maximize the semblance function:

$$S ( {x}_{0} , {y}_{0} ) = \frac{{\sum }_{j = 1}^{N} {\{ {\sum }_{j = 1}^{M} u [ {x}_{i} , {y}_{i} , {t}_{j} ( {x}_{0} , {y}_{0} ) + Δ t ( {x}_{i} , {y}_{i} ; {x}_{0} , {y}_{0} ) ] \}}^{2}}{M {\sum }_{j = 1}^{N} {\sum }_{j = 1}^{M} {\{ u [ {x}_{i} , {y}_{i} , {t}_{j} ( {x}_{0} , {y}_{0} ) + Δ t ( {x}_{i} , {y}_{i} ; {x}_{0} , {y}_{0} ) ] \}}^{2}} . \qquad ( 3 )$$

The performance of the SNR enhancement and the quality of the results significantly depends on the allowable intervals of the parameters [Aₘᵢₙ, Aₘₐₓ], [Bₘᵢₙ, Bₘₐₓ], [Cₘᵢₙ, Cₘₐₓ], [Dₘᵢₙ, Dₘₐₓ], [Eₘᵢₙ, Eₘₐₓ], which serve as input parameters to the process. Though there are physics-based approaches to define these intervals based on some simplified assumptions, they often are not able to handle all the complexities of real wavefields. This is particularly true for refracted and diving waves, which can be severely affected by the near-surface anomalies and complex topography. In practice, the intervals are often defined by the user using a trial-and-error approach. Large intervals tremendously increase the computational time making the data enhancement methods unaffordable in real practical applications. Small intervals can lead to a significant degradation of the quality of the enhancement results. The process 100 of FIG. 1 enables an automatic and more efficient interval definition.

At block 102, wavefront attributes are estimated using initial search intervals for a reduced representative subset of the whole dataset (e.g. 1% of the whole dataset). In examples, the initial search intervals are sized by determining at least one range defined by initial minimum and maximum values. In some embodiments, the initial search intervals are sized using a trial-and-error approach or by using a priori knowledge about the minimum and maximum values of seismic velocities in the medium and dips and curvatures of geologic boundaries. In the trial-and-error approach, the user sets the values of the interval manually and ensures that the data quality after data-enhancement procedure is not deteriorating. A priori knowledge about the minimum and maximum values of seismic velocities in the medium is based on, for example, historic or previously captured data associated with seismic velocities in the medium and dips and curvatures of geologic boundaries. In examples, the minimum and maximum values of seismic velocities in the medium is extracted from historical data stored in a database.

At block 104, a semblance threshold is selected corresponding to reliably estimated wavefront attributes. In some embodiments, the semblance threshold varies according to a time and/or offset based on the trial-and-error approach or some statistical criteria (for example range between 5%- and 95%-percentiles for a specific time or offset intervals). In examples, a user divides the full offset or time ranges into bins. For each of the bins, a threshold is set, for example, to obtain wavefront attributes with semblance values between 5%- and 95%-percentiles of semblance values. In the trial-and-error approach, the user sets the threshold manually for each of the offset and time bins and ensures that the data quality after data-enhancement procedure is not deteriorating.

In some embodiments, semblance is a quantitative measure of the coherence of seismic data from multiple channels that is equal to the energy of a stacked trace divided by the energy of all the traces that make up the stack. If data from all channels are perfectly coherent, or show continuity from trace to trace, the semblance has a value of unity. In some embodiments, semblance is estimated by determining a ratio of the energy of a first trace to the energy of neighboring traces within an analysis window. In examples, semblance values near or equal to zero indicate high similarity of a sample trace to its neighboring traces while values closer to one indicate high dissimilarity.

At block 106, unreliable events with the semblance values below the selected threshold are omitted from further consideration.

At block 108, the remaining estimated wavefront attributes are rotated to align them along the radial direction going from the center of the gather to the point of the regular estimation grid in the X-Y-T volume, at which the wavefront attributes are currently estimated.

At block 110, optimized search intervals are selected in the rotated coordinates based on statistical criteria (for example range between 5%- and 95%-percentiles). In some embodiments, selecting search intervals in the rotated coordinates enables the use of physical properties to constrain the wavefront attributes obtained using the search intervals. For example, distributions of wavefront attributes are transformed by rotating the distribution of wavefront attribute values to reduce corresponding intervals. The rotation reduces the size of the search intervals by transforming the coordinates and aligning the wavefront attributes with ray parameters. This effect is shown in Table 1. In some embodiments, physical properties of the media are used to constrain the search intervals. For example, properties as the minimum and maximum expected seismic wave velocities in the area are applied as constraints to the search intervals. At block 112, the wavefront attributes are estimated for the whole dataset using the obtained optimized search interval values.

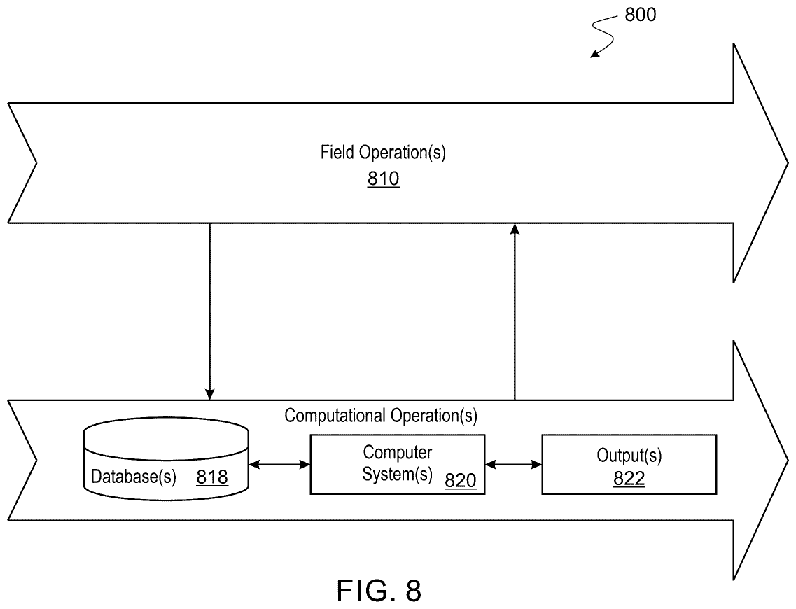

At block 114, the estimated wavefront attributes can be transformed back to the original coordinates and used for data-enhancement or other tasks. In examples, the estimated wavefront attributes are transformed into an original time domain. Data-enhancement or other tasks include, for example, signal-to-noise ratio estimation, seismic tomography, advanced seismic stacking techniques, or any combinations thereof. In signal-to-noise ratio estimation, the quantifiable difference between the desired signal strength and the unwanted noise by subtracting the noise value from the signal strength value. The resulting clean signal is used in hydrocarbon production operations 800 as described with respect to FIG. 8. In seismic tomography, seismic waves generated by earthquakes and explosions to create computer-generated, three-dimensional images of Earth's interior. The seismic waves are enhanced, and the resulting seismic data is used in hydrocarbon production operations 800 as described with respect to FIG. 8. In advanced seismic stacking techniques, seismic data containing traces added together from different seismic records are combined to reduce noise and improve overall data quality. The seismic data is used in hydrocarbon production operations 800 as described with respect to FIG. 8.

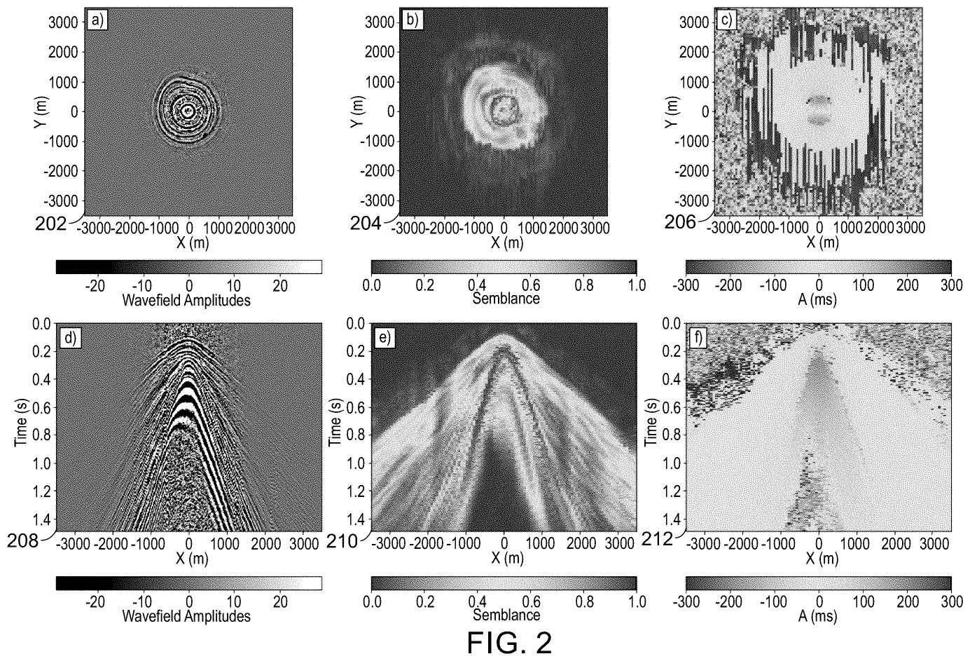

FIG. 2 shows an example of seismic data. In the example of FIG. 2, plots 202 and 208 show seismic data, the corresponding estimated maximum semblance values at plots 204 and 210, and the dip parameter A at plots 206 and 212. The top row, plots 202, 204, and 208, show a time slice from a common shot gather with a shot located in the middle of the spread. The bottom row, plots 208, 210, and 212, show an inline slice extracted at a constant value of Y from the same common-shot gather. The dip parameter A is represented in milliseconds as the travel-time moveout at the distance of 200 m from the estimated point.

In examples, plots 202 and 208 show an example of an unprocessed seismic common-shot gather with a shot located in the middle of the receiver's spread. The estimated high values of semblance shown in plots 204 and 210 show the most coherent and reliable seismic events. The estimated dip parameters A in plots 206 and 212 are shown using black histograms in milliseconds as the travel-time moveouts (AΔx) at the distance of Δx=200 m away from the estimation location. As can be seen, the estimated values of the parameter vary significantly, especially in the areas not reached by the wavefront. In this area, they tend to behave as random variables since no seismic energy is present there. The histograms in FIG. 2 show the distribution of the estimated parameters. Similar to the previous representation, wavefront attributes are transformed to milliseconds by multiplying the estimated values by Δx=200 m for dips (A and B), and by Δx²=40000 m² for curvatures (C, D, E). As can be seen, the distribution of values is quite wide, varying approximately from −300 ms to 300 ms for dips and from −40 ms to 40 ms for curvatures, which was used as the minimum and maximum search values in the current example.

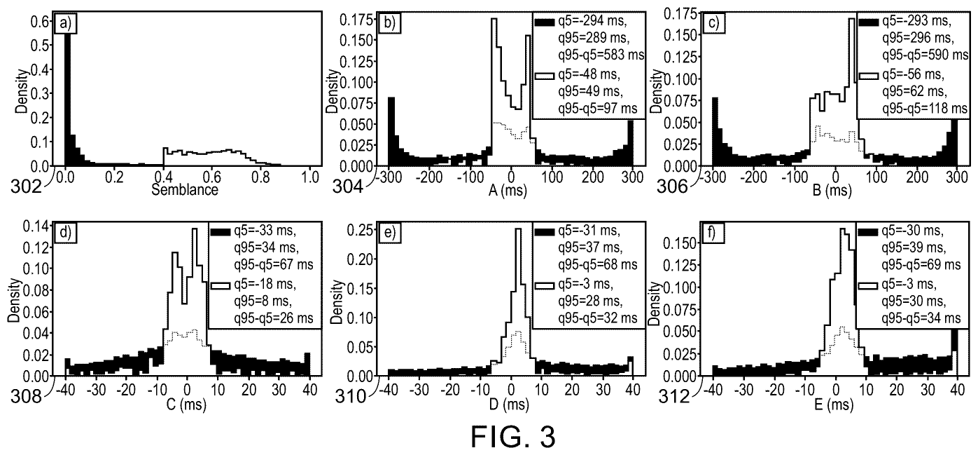

FIG. 3 shows histograms with a distribution of estimated semblance values. In the plots 302-312 of FIG. 3, black histograms show an initial distribution of the estimated semblance values and the corresponding wavefront attributes for the whole common-shot gather from FIG. 2. White histograms show the distribution of the corresponding values after removing events with an estimated semblance value of less than 0.4, which is selected as the threshold between reliable and unreliable events in this example.

Accordingly, in examples an estimated semblance value is used to determine the semblance threshold. By considering only the most reliable events with semblance values above 0.4 (FIG. 3), the intervals of the possible values of the parameters are shrunk significantly (FIG. 3, white histograms). The reduction of the interpercentile range between 95%-percentile (P₉₅) and 5%-percentile (P₅) for all parameters is shown in Table 1 (first and second columns). The reduction in the intervals is around five times for dips and three times for curvatures. Considering that the wavefront attributes are defined on a grid with constant step size (e.g. 1 ms), the achieved reduction of the total search space in the presented example is 334 times, according to Table 1.

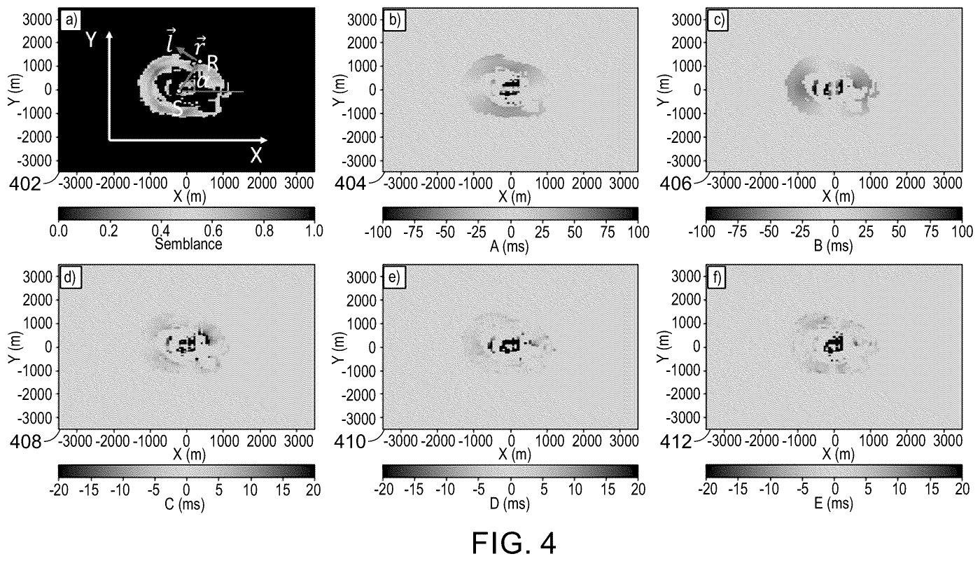

FIG. 4 shows estimated maximum semblance values. FIG. 4 shows the estimated maximum semblance values at plot 402 and the corresponding wavefront attributes A-E at plots 404-412 after filtering out events below the semblance threshold. In plot 402, vector \vec{r} connects the source position (S) and the receiver position (R), vector \vec{l} is orthogonal to \vec{r}, α is the angle between \vec{r} and horizontal axis. As shown in FIG. 4, extra variability of the parameters (especially for A, B and C) is related to their orientation along the X and Y coordinate axis. To reduce this variability, an additional or subsequent rotation can be performed according to the below formula:

$$( \begin{matrix}Δ r \\ Δ l\end{matrix} ) = {Q}^{- 1} ( \begin{matrix}Δ x \\ Δ y\end{matrix} ) , \qquad ( 4 )$$

where Δ r is the component of the trace shift along vector \vec{r}, which connects the source position (S) and the receiver position (R) (plot 402 of FIG. 4), and Δl is the component along vector \vec{l}, orthogonal to \vec{r}. Q is the rotational orthogonal matrix defined as follows:

$$Q = ( \begin{matrix}cos α & sin α \\ - sin α & cos α\end{matrix} ) , \qquad ( 5 )$$

where α is the angle between vector \vec{r} and horizontal axis X. Accordingly, in some embodiments subsequent rotation of the retained wavefront attributes is performed to reduce variability of the retained wavefront attributes.

Substituting equation (4) into equation (2) yields the following relation:

$$Δ t = ( A , B ) Q ( \begin{matrix}Δ r \\ Δ l\end{matrix} ) + ( Δ r , Δ l ) {Q}^{T} ( \begin{matrix}D & C \\ C & E\end{matrix} ) Q ( \begin{matrix}Δ r \\ Δ l\end{matrix} ) = ( \tilde{A} , \tilde{B} ) ( \begin{matrix}Δ r \\ Δ l\end{matrix} ) + ( Δ r , Δ l ) ( \begin{matrix}\tilde{D} & \tilde{C} \\ \tilde{C} & \tilde{E}\end{matrix} ) ( \begin{matrix}Δ r \\ Δ l\end{matrix} ) , \qquad ( 6 )$$

where coefficients Ã, \tilde{B}, \tilde{C}, \tilde{D}, \tilde{E} are the new transformed wavefront attributes obtained after the rotation. In examples, translational components are transformed into rotational components.

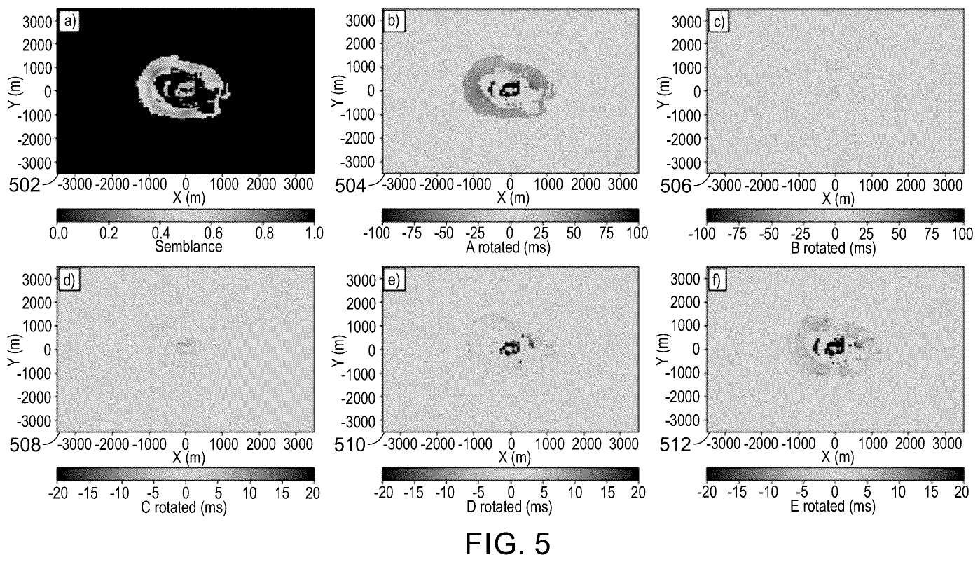

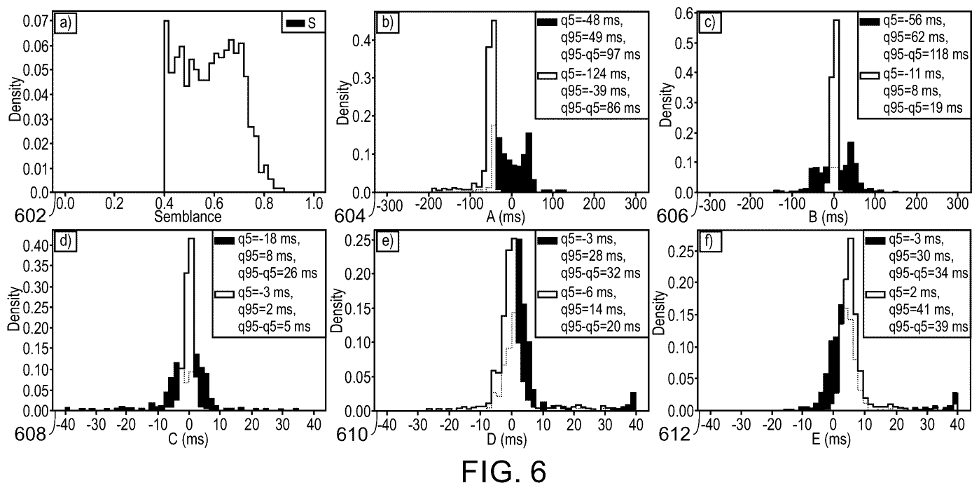

FIG. 5 shows the new transformed wavefront attributes obtained after the rotation. Semblance is shown on the plot 502, and wavefront attributes A-E are shown at plots 504-512. As shown in FIG. 5, wavefront attribute A now has negative values in each direction, while the values of wavefront attribute B are significantly decreased. FIG. 5 is the same as in FIG. 3, but after rotating to match with radial direction \vec{r}. FIG. 6 shows a distribution of wavefront attribute values before (black) and after rotation (white). Semblance is shown on the plot 602, and wavefront attributes A-E are shown at plots 604-612. The distributions of the modified wavefront attributes for the given example are shown in FIG. 6. It confirms that the corresponding intervals have shrunk for most of the parameters, as shown at Table 1, third column. The interpercentile range (P₉₅P₅) for parameter B has decreased by six times and for parameter C by five times compared to the parameters before the rotation. Overall, the additional reduction of the search space achieved by the rotation is 50 times. Including the previous reduction obtained by constraining the semblance values, the total reduction of the possible values of parameters is around 17,000 times in this example.

TABLE 1
Initial and optimized ranges of the intervals for different wavefront
attributes according to the histograms from FIGS. 3 and FIG. 6.

| | Interpercentile range (P₉₅-P₅) | | | |
|---|---|---|---|---|
| | | | After semblance- | After additional |
| Parameter | | Initial | based truncation | rotation |

| Dip A | 583 | ms | 97 | | 86 | ms |
|---|---|---|---|---|---|---|
| Dip B | 590 | ms | 118 | ms | 19 | ms |
| Curvature C | 67 | ms | 26 | ms | 5 | ms |
| Curvature D | 68 | ms | 32 | ms | 20 | ms |
| Curvature E | 69 | ms | 34 | ms | 39 | ms |

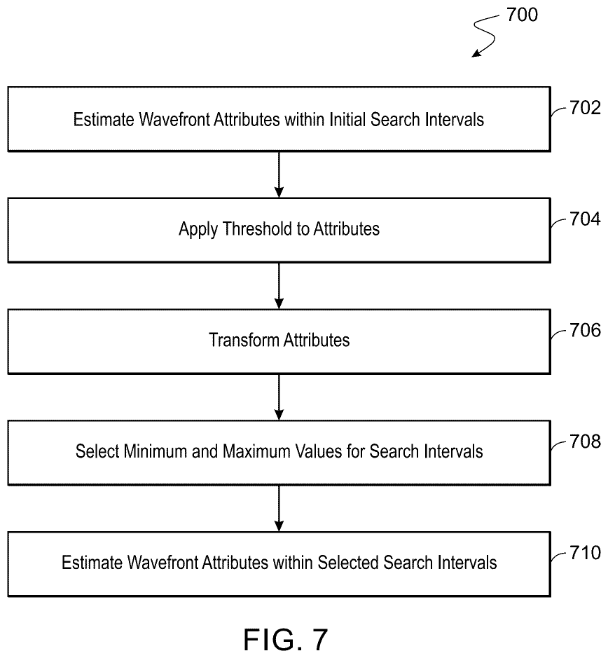

FIG. 7 is a process flow diagram of a process 700 that constrains prestack seismic wavefront attributes. In examples, the process implements the workflow 100 as described with respect to FIG. 1. In some embodiments, the original traces are an original seismic dataset in the time domain. The original seismic dataset is decomposed or transformed into the time-frequency (TF) domain using short-time Fourier transform (STFT). In the TF domain (e.g., the transformed domain), the output traces are constructed using the TF spectra of the original and enhanced traces. Once generated in the TF domain, the output traces are synthesized into the time domain using inverse short-time Fourier transform (ISTFT). For each seismic trace of the plurality of seismic traces, a respective output trace corresponding to the seismic trace is generated, wherein the respective output traces collectively form an output seismic dataset. In some embodiments, the process 700 executes automatically, without human input or intervention.

At block 702, the wavefront attributes are estimated within initial search intervals on a small but representative subset of the whole, original dataset. In examples, the dataset is a seismic dataset measured and recorded with reference to a particular area of the Earth's surface, to evaluate the subsurface. In examples, the seismic data is captured using modern arrays, small field arrays, single-sensor systems, or any combinations thereof. In examples, the seismic data is captured over a predetermined time period.

In examples, the initial search intervals are sized using a reduced representative subset of the whole dataset (e.g. 1% of the whole dataset). For example, the initial search intervals are sized by determining at least one range defined by initial minimum and maximum values. In examples, the initial search intervals are sized using a trial-and-error approach or by using a priori knowledge about the minimum and maximum values of seismic velocities in the medium and dips and curvatures of geologic boundaries. Additionally, in examples, unknown coefficients A, B (wavefront first spatial derivatives, or dips) and C, D, E (wavefront second derivatives, or curvatures) are estimated on some grid of possible values in the initial search intervals by using either a brute-force searching or global optimization algorithm to maximize the semblance function.

At block 704, a thresholding of the wavefront attributes based on a semblance value is performed to retain the most reliable events for further processing. In examples, the threshold varies depending on time and/or offset. At block 706, a transformation of the wavefront attributes reduces the ranges of possible values. The remaining estimated wavefront attributes are rotated to align them along the radial direction going from the center of the gather to the estimated grid point.

At block 708, the minimum and maximum values of the wavefront attributes are selected based on statistical criteria in the transformed domain. In examples, the search intervals are selected in the rotated coordinates based on, at least in part, statistical criteria (for example range between 5%- and 95%-percentiles).

At block 710, the selected ranges are used to estimate the wavefront attributes in the whole, original dataset. In examples, the wavefront attributes are estimated for the whole, original dataset using the obtained optimized interval values. The estimated wavefront attributes are transformed back to the original coordinates and used for data-enhancement or other tasks. In examples, the estimated wavefront attributes are automatically integrated into surface-consistent scaling and deconvolution, statics estimation, velocity analysis, and the like as part of exploration seismology. In examples, the wavefront attributes are estimated for large datasets using sequential estimation of wavefront attributes on a sparse estimation grid, interpolation of the estimated wavefront attributes to a dense estimation grid, group data summation of the data to a sparse grid, operator-oriented summation from the sparse grid to a dense original data grid, amplitude-phase correction of the summed data, or any combinations thereof. In examples, the wavefront attributes are estimated using artificial intelligence.

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

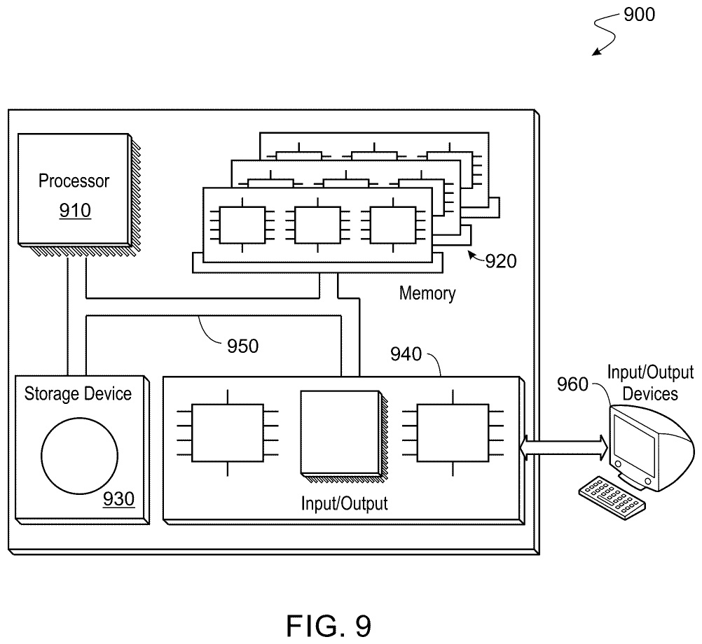

FIG. 9 is a schematic illustration of an example controller 900 (or control system) for that enables constrained prestack seismic wavefront attributes. For example, the controller 900 may be operable according to the workflow 100 of FIG. 1 or the process 700 of FIG. 7. In some embodiments, the controller 900 is the same as or similar to the computer systems 820 of FIG. 8. The controller 900 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 900 includes a processor 910, a memory 920, a storage device 930, and an input/output interface 940 communicatively coupled with input/output devices 960 (for example, displays, keyboards, measurement devices, sensors, valves, pumps). Each of the components 910, 920, 930, and 940 are interconnected using a system bus 950. The processor 910 is capable of processing instructions for execution within the controller 900. The processor may be designed using any of a number of architectures. For example, the processor 910 may be a CISC (Complex Instruction Set Computers) processor, a RISC (Reduced Instruction Set Computer) processor, or a MISC (Minimal Instruction Set Computer) processor.

In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output interface 940.

The memory 920 stores information within the controller 900. In one implementation, the memory 920 is a computer-readable medium. In one implementation, the memory 920 is a volatile memory unit. In another implementation, the memory 920 is a nonvolatile memory unit.

The storage device 930 is capable of providing mass storage for the controller 900. In one implementation, the storage device 930 is a computer-readable medium. In various different implementations, the storage device 930 may be a floppy disk device, a hard disk device, an optical disk device, or a tape device.

The input/output interface 940 provides input/output operations for the controller 900. In one implementation, the input/output devices 960 includes a keyboard and/or pointing device. In another implementation, the input/output devices 960 includes a display unit for displaying graphical user interfaces.

There can be any number of controllers 900 associated with, or external to, a computer system containing controller 900, with each controller 900 communicating over a network. Further, the terms “client,” “user,” and other appropriate terminology can be used interchangeably, as appropriate, without departing from the scope of the present disclosure. Moreover, the present disclosure contemplates that many users can use one controller 900 and one user can use multiple controllers 900.

### Embodiments

According to some non-limiting embodiments or examples, provided is a computer-implemented method that constrains prestack seismic wavefront attributes, including: estimating, using at least one hardware processor, wavefront attributes in intervals sized to include a representative subset of an original seismic dataset; applying, using the at least one hardware processor, a semblance threshold to the wavefront attributes based on an estimated semblance value, wherein wavefront attributes that satisfy the semblance threshold are retained; transforming, using the at least one hardware processor, the retained wavefront attributes to reduce a range of possible values; selecting, using the at least one hardware processor, minimum and maximum values of the wavefront attributes based on statistical criteria; and estimating, using the at least one hardware processor, wavefront attributes for the original seismic dataset using the selected minimum and maximum values of the wavefront attributes.

According to some non-limiting embodiments or examples, provided is an apparatus including a non-transitory, computer readable, storage medium that stores instructions that, when executed by at least one processor, cause the at least one processor to perform operations including: estimating wavefront attributes in intervals sized to include a representative subset of an original seismic dataset; applying a semblance threshold to the wavefront attributes based on an estimated semblance value, wherein wavefront attributes that satisfy the semblance threshold are retained; transforming the retained wavefront attributes to reduce a range of possible values; selecting minimum and maximum values of the wavefront attributes based on statistical criteria; and estimating wavefront attributes for the original seismic dataset using the selected minimum and maximum values of the wavefront attributes.

According to some non-limiting embodiments or examples, provided is a system, including: one or more memory modules; one or more hardware processors communicably coupled to the one or more memory modules, the one or more hardware processors configured to execute instructions stored on the one or more memory models to perform operations including: estimating wavefront attributes in intervals sized to include a representative subset of an original seismic dataset; applying a semblance threshold to the wavefront attributes based on an estimated semblance value, wherein wavefront attributes that satisfy the semblance threshold are retained; transforming the retained wavefront attributes to reduce a range of possible values; selecting minimum and maximum values of the wavefront attributes based on statistical criteria; and estimating wavefront attributes for the original seismic dataset using the selected minimum and maximum values of the wavefront attributes.

Further non-limiting aspects or embodiments are set forth in the following numbered embodiments:

Embodiment 1: A computer-implemented method that constrains prestack seismic wavefront attributes, including: estimating, using at least one hardware processor, wavefront attributes in intervals sized to include a representative subset of an original seismic dataset; applying, using the at least one hardware processor, a semblance threshold to the wavefront attributes based on an estimated semblance value, wherein wavefront attributes that satisfy the semblance threshold are retained; transforming, using the at least one hardware processor, the retained wavefront attributes to reduce a range of possible values; selecting, using the at least one hardware processor, minimum and maximum values of the wavefront attributes based on statistical criteria; and estimating, using the at least one hardware processor, wavefront attributes for the original seismic dataset using the selected minimum and maximum values of the wavefront attributes.

Embodiment 2: The computer-implemented method of any preceding embodiment, wherein selecting minimum and maximum values of the wavefront attributes based on statistical criteria is performed in a time-frequency domain.

Embodiment 3: The computer-implemented method of any preceding embodiment, wherein transforming the retained wavefront attributes to reduce a range of possible values includes rotating the distribution of wavefront attribute values to reduce corresponding intervals.

Embodiment 4: The computer-implemented method of any preceding embodiment, including transforming the estimated wavefront attributes into a time domain.

Embodiment 5: The computer-implemented method of any preceding embodiment, wherein the estimated semblance value is determined by determining a ratio of energy of a first trace to the energy of neighboring traces.

Embodiment 6: The computer-implemented method of any preceding embodiment, including performing a subsequent rotation of the retained wavefront attributes to reduce variability of the retained wavefront attributes.

Embodiment 7: The computer-implemented method of any preceding embodiment, wherein the original seismic dataset includes a plurality of seismic traces captured from an environment, the method further including: for each seismic trace of the plurality of seismic traces, generating a respective output trace corresponding to the seismic trace, wherein the respective output traces collectively form an output seismic dataset.

Embodiment 8: An apparatus including a non-transitory, computer readable, storage medium that stores instructions that, when executed by at least one processor, cause the at least one processor to perform operations including: estimating wavefront attributes in intervals sized to include a representative subset of an original seismic dataset; applying a semblance threshold to the wavefront attributes based on an estimated semblance value, wherein wavefront attributes that satisfy the semblance threshold are retained; transforming the retained wavefront attributes to reduce a range of possible values; selecting minimum and maximum values of the wavefront attributes based on statistical criteria; and estimating wavefront attributes for the original seismic dataset using the selected minimum and maximum values of the wavefront attributes.

Embodiment 9: The apparatus of any preceding embodiment, wherein selecting minimum and maximum values of the wavefront attributes based on statistical criteria is performed in a time-frequency domain.

Embodiment 10: The apparatus of any preceding embodiment, wherein transforming the retained wavefront attributes to reduce a range of possible values includes rotating the distribution of wavefront attribute values to reduce corresponding intervals.

Embodiment 11: The apparatus of any preceding embodiment, including transforming the estimated wavefront attributes into a time domain.

Embodiment 12: The apparatus of any preceding embodiment, wherein the estimated semblance value is determined by determining a ratio of energy of a first trace to the energy of neighboring traces.

Embodiment 13: The apparatus of any preceding embodiment, including performing a subsequent rotation of the retained wavefront attributes to reduce variability of the retained wavefront attributes.

Embodiment 14: The apparatus of any preceding embodiment, wherein the original seismic dataset includes a plurality of seismic traces captured from an environment, the method further including: for each seismic trace of the plurality of seismic traces, generating a respective output trace corresponding to the seismic trace, wherein the respective output traces collectively form an output seismic dataset.

Embodiment 15: A system, including: one or more memory modules; one or more hardware processors communicably coupled to the one or more memory modules, the one or more hardware processors configured to execute instructions stored on the one or more memory models to perform operations including: estimating wavefront attributes in intervals sized to include a representative subset of an original seismic dataset; applying a semblance threshold to the wavefront attributes based on an estimated semblance value, wherein wavefront attributes that satisfy the semblance threshold are retained; transforming the retained wavefront attributes to reduce a range of possible values; selecting minimum and maximum values of the wavefront attributes based on statistical criteria; and estimating wavefront attributes for the original seismic dataset using the selected minimum and maximum values of the wavefront attributes.

Embodiment 16: The system of any preceding embodiment, wherein selecting minimum and maximum values of the wavefront attributes based on statistical criteria is performed in a time-frequency domain.

Embodiment 17: The system of any preceding embodiment, wherein transforming the retained wavefront attributes to reduce a range of possible values includes rotating the distribution of wavefront attribute values to reduce corresponding intervals.

Embodiment 18: The system of any preceding embodiment, including transforming the estimated wavefront attributes into a time domain.

Embodiment 19: The system of any preceding embodiment, wherein the estimated semblance value is determined by determining a ratio of energy of a first trace to the energy of neighboring traces.

Embodiment 20: The system of any preceding embodiment, including performing a subsequent rotation of the retained wavefront attributes to reduce variability of the retained wavefront attributes.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that constrains prestack seismic wavefront attributes, comprising:
estimating, using at least one hardware processor, wavefront attributes in intervals sized to include a representative subset of an original seismic dataset;
applying, using the at least one hardware processor, a semblance threshold to the wavefront attributes based on an estimated semblance value, wherein wavefront attributes that satisfy the semblance threshold are retained;
transforming, using the at least one hardware processor, the retained wavefront attributes to reduce a range of possible values;
selecting, using the at least one hardware processor, minimum and maximum values of the wavefront attributes based on statistical criteria; and
estimating, using the at least one hardware processor, wavefront attributes for the original seismic dataset using the selected minimum and maximum values of the wavefront attributes.

2. The computer-implemented method of claim 1, wherein selecting minimum and maximum values of the wavefront attributes based on statistical criteria is performed in a time-frequency domain.

3. The computer-implemented method of claim 1, wherein transforming the retained wavefront attributes to reduce a range of possible values comprises rotating the distribution of wavefront attribute values to reduce corresponding intervals.

4. The computer-implemented method of claim 1, comprising transforming the estimated wavefront attributes into a time domain.

5. The computer-implemented method of claim 1, wherein the estimated semblance value is determined by determining a ratio of energy of a first trace to the energy of neighboring traces.

6. The computer-implemented method of claim 1, comprising performing a subsequent rotation of the retained wavefront attributes to reduce variability of the retained wavefront attributes.

7. The computer-implemented method of claim 1, wherein the original seismic dataset comprises a plurality of seismic traces captured from an environment, the method further comprising:
for each seismic trace of the plurality of seismic traces, generating a respective output trace corresponding to the seismic trace, wherein the respective output traces collectively form an output seismic dataset.

8. An apparatus comprising a non-transitory, computer readable, storage medium that stores instructions that, when executed by at least one processor, cause the at least one processor to perform operations comprising:
estimating wavefront attributes in intervals sized to include a representative subset of an original seismic dataset;
applying a semblance threshold to the wavefront attributes based on an estimated semblance value, wherein wavefront attributes that satisfy the semblance threshold are retained;
transforming the retained wavefront attributes to reduce a range of possible values;
selecting minimum and maximum values of the wavefront attributes based on statistical criteria; and
estimating wavefront attributes for the original seismic dataset using the selected minimum and maximum values of the wavefront attributes.

9. The apparatus of claim 8, wherein selecting minimum and maximum values of the wavefront attributes based on statistical criteria is performed in a time-frequency domain.

10. The apparatus of claim 8, wherein transforming the retained wavefront attributes to reduce a range of possible values comprises rotating the distribution of wavefront attribute values to reduce corresponding intervals.

11. The apparatus of claim 8, comprising transforming the estimated wavefront attributes into a time domain.

12. The apparatus of claim 8, wherein the estimated semblance value is determined by determining a ratio of energy of a first trace to the energy of neighboring traces.

13. The apparatus of claim 8, comprising performing a subsequent rotation of the retained wavefront attributes to reduce variability of the retained wavefront attributes.

14. The apparatus of claim 8, wherein the original seismic dataset comprises a plurality of seismic traces captured from an environment, the method further comprising:
for each seismic trace of the plurality of seismic traces, generating a respective output trace corresponding to the seismic trace, wherein the respective output traces collectively form an output seismic dataset.

15. A system, comprising:
one or more memory modules;
one or more hardware processors communicably coupled to the one or more memory modules, the one or more hardware processors configured to execute instructions stored on the one or more memory models to perform operations comprising:
estimating wavefront attributes in intervals sized to include a representative subset of an original seismic dataset;
applying a semblance threshold to the wavefront attributes based on an estimated semblance value, wherein wavefront attributes that satisfy the semblance threshold are retained;
transforming the retained wavefront attributes to reduce a range of possible values;
selecting minimum and maximum values of the wavefront attributes based on statistical criteria; and
estimating wavefront attributes for the original seismic dataset using the selected minimum and maximum values of the wavefront attributes.

16. The system of claim 15, wherein selecting minimum and maximum values of the wavefront attributes based on statistical criteria is performed in a time-frequency domain.

17. The system of claim 15, wherein transforming the retained wavefront attributes to reduce a range of possible values comprises rotating the distribution of wavefront attribute values to reduce corresponding intervals.

18. The system of claim 15, comprising transforming the estimated wavefront attributes into a time domain.

19. The system of claim 15, wherein the estimated semblance value is determined by determining a ratio of energy of a first trace to the energy of neighboring traces.

20. The system of claim 15, comprising performing a subsequent rotation of the retained wavefront attributes to reduce variability of the retained wavefront attributes.
